(19) United States
(12) Patent Application Publication
(10) Pub. No.: US 2024/0330703 A1
(43) Pub. Date: Oct. 3, 2024

(54) MACHINE LEARNING DEVICE, MACHINE LEARNING METHOD, AND NON-TRANSITORY COMPUTER-READABLE MEDIUM HAVING MACHINE LEARNING PROGRAM

(71) Applicant: JVCKENWOOD Corporation, Yokohama-shi (JP)

(72) Inventor: Shingo KIDA, Yokohama-shi (JP)

(21) Appl. No.: 18/739,389

(22) Filed: Jun. 11, 2024

Related U.S. Application Data
(63) Continuation of application No. PCT/JP2022/033365, filed on Sep. 6, 2022.

(30) Foreign Application Priority Data
Dec. 23, 2021 (JP) 2021-209555

(51) Int. Cl. G06N 3/096; G06N 3/045

(52) U.S. Cl. CPC G06N 3/096; G06N 3/045

(57) ABSTRACT

A pre-trained feature extraction unit extracts feature vectors of samples in a base class using a pre-trained model. A base class classification weight is for classifying the samples in the base class using the classification weight of the base class while using the feature vectors of the samples in the base class as input. A feature optimization unit performs meta-learning of an optimization module that is based on the pre-trained model and optimizes feature vectors of samples in a novel class. A novel class feature averaging unit averages the feature vectors of the samples in the novel class for each class and calculates the classification weight of the novel class. A graph neural network uses the classification weights of the base class and novel class as input, performs meta-learning of the dependence relationship between the base and novel classes, and outputs a reconstruction classification weight.

### CROSS REFERENCE TO RELATED APPLICATION

This application is a continuation of application No. PCT/JP2022/033365, filed on Sep. 6, 2022, and claims the benefit of priority from the prior Japanese Patent Application No. 2021-209555, filed on Dec. 23, 2021, the entire content of which is incorporated herein by reference.

### BACKGROUND

### 1. Technical Field

The present disclosure relates to machine learning technologies.

### 2. Description of the Related Art

Human beings can learn new knowledge through experiences over a prolonged period of time and can maintain old knowledge without forgetting it. Meanwhile, the knowledge of a convolutional neutral network (CNN) depends on the dataset used in learning. To adapt to a change in data distribution, it is necessary to re-train CNN parameters in response to the entirety of the dataset. In CNN, the precision estimation for old tasks will be decreased as new tasks are learned. Thus, catastrophic forgetting cannot be avoided in CNN. Namely, the result of learning old tasks is forgotten as new tasks are being learned in successive learning.

Incremental learning or continual learning is proposed as a scheme to avoid catastrophic forgetting. Continual learning is a learning method that improves a current trained model to learn new tasks and new data as they occur, instead of training the model from scratch.

On the other hand, since new tasks often have only a few pieces of sample data available, few-shot learning has been proposed as a method for efficient learning with a small amount of training data. In few-shot learning, new tasks are learned using another small amount of parameters without relearning parameters that have been learned once.

A method called incremental few-shot learning (IFSL) has been proposed, which combines continual learning, where a novel class is learned without catastrophic forgetting of the result of learning the base class, and few-shot learning, where a novel class with fewer examples as compared to the base class is learned (Non-Patent Literature 1). In incremental few-shot learning, base classes can be learned from a large dataset and novel classes can be learned from a small number of sample data pieces.

As an incremental few-shot learning method, a method for learning the reconstruction of classification weights, also called “prototypes,” using a graph neural network (GNN) has been proposed (Non-Patent Literature 2). Further, as an incremental few-shot learning method, a method for learning the reconstruction of classification weights using a graph attention network (GAT) has been proposed (Non-Patent Literature 3).
[Non-Patent Literature 1] Yoon, S. W., Kim, D. Y., Seo, J., & Moon, J. (2020 November). XtarNet: Learning to extract task-adaptive representation for incremental few-shot learning. In International Conference on Machine Learning (pp. 10852-10860). PMLR
[Non-Patent Literature 2] Gidaris, S., & Komodakis, N. (2019). Generating classification weights with GNN denoising autoencoders for few-shot learning. In Proceedings of the IEEE/CVF Conference on Computer Vision and Pattern Recognition (pp. 21-30)
[Non-Patent Literature 3] Zhang, C., Song, N., Lin, G., Zheng, Y., Pan, P., & Xu, Y. (2021). Few-shot incremental learning with continually evolved classifiers. In Proceedings of the IEEE/CVF Conference on Computer Vision and Pattern Recognition (pp. 12455-12464)

In the methods described in Non-Patent Literatures 2 and 3, since learning of the reconstruction of class classification weights is performed while a feature extractor is fixed, the features of each image sample themselves do not change, and only the class classification weights are adjusted. Therefore, there is a problem that the features of an image sample and the corresponding class classification weights are separated and that the class classification accuracy may thus be reduced.

### SUMMARY

In order to solve the aforementioned problems, a machine learning device according to one embodiment relates to a machine learning device that performs continual learning of a novel class with fewer samples than a base class, including: a base class feature extraction unit that extracts feature vectors of samples in the base class using a pre-trained model; a base class classification unit that uses feature vectors of the samples in the base class as input and classifies the samples in the base class using the classification weight of the base class; a feature optimization unit that performs meta-learning of an optimization module that is based on the pre-trained model and optimizes feature vectors of samples in the novel class; a novel class feature averaging unit that averages the feature vectors of the samples in the novel class for each class and calculates the classification weight of the novel class; a graph neural network that uses the classification weight of the base class and the classification weight of the novel class as input, performs meta-learning of the dependence relationship between the base class and the novel class, and outputs a reconstruction classification weight; and an unknown class classification unit that uses, as input, feature vectors of samples in an unknown class extracted using the optimization module and classifies the samples in the unknown class using the reconstruction classification weight.

Another embodiment also relates to a machine learning device. This device is a machine learning device that performs continual learning of a novel class with fewer samples than a base class, including: a base class feature extraction unit that extracts feature vectors of samples in the base class using a pre-trained model; a base class classification unit that uses feature vectors of the samples in the base class as input and classifies the samples in the base class using the classification weight of the base class; a feature optimization unit that performs meta-learning of an optimization module that is based on the pre-trained model and optimizes feature vectors of samples in the novel class; a novel class feature averaging unit that averages the feature vectors of the samples in the novel class for each class and calculates the classification weight of the novel class; a graph attention network that uses the classification weight of the base class and the classification weight of the novel class as input, performs meta-learning of the dependence relationship between the base class and the novel class, and outputs a reconstruction classification weight; and an unknown class classification unit that uses, as input, feature vectors of samples in an unknown class extracted using the optimization module and classifies the samples in the unknown class using the reconstruction classification weight.

Yet another embodiment relates to a machine learning method. This method is a machine learning method that performs continual learning of a novel class with fewer samples than a base class, including: extracting feature vectors of samples in the base class using a pre-trained model; using feature vectors of the samples in the base class as input and classifying the samples in the base class using the classification weight of the base class; performing meta-learning of an optimization module that is based on the pre-trained model and optimizing feature vectors of samples in the novel class; averaging the feature vectors of the samples in the novel class for each class and calculating the classification weight of the novel class; using the classification weight of the base class and the classification weight of the novel class as input, performing meta-learning of the dependence relationship between the base class and the novel class, and outputting a reconstruction classification weight, while using a graph neural network or a graph attention network; and using, as input, feature vectors of samples in an unknown class extracted using the optimization module and classifying the samples in the unknown class using the reconstruction classification weight.

Optional combinations of the aforementioned constituting elements and implementations of the present embodiments in the form of methods, apparatuses, systems, recording mediums, and computer programs may also be practiced as additional modes of the present embodiments.

### BRIEF DESCRIPTION OF THE DRAWINGS

The disclosure will be described with reference to the following drawings.

FIG. 1A is a diagram explaining the configuration of a pre-training module.

FIG. 1B is a diagram explaining the configuration of an incremental few-shot learning module.

FIG. 1C is a diagram explaining episodic training.

FIG. 2A is a diagram explaining a configuration for generating task-specific merged weight vectors for calculating a task-adaptive representation from a support set.

FIG. 2B is a diagram explaining a configuration for calculating a task-adaptive representation from a support set so as to generate a classification weight vector set W based on the task-adaptive representation.

FIG. 3 is a diagram explaining a configuration for calculating a task-adaptive representation from a query set and classifying a query sample into classes based on the task-adaptive representation and a task-adjusted classification weight vector set so as to minimize class classification loss.

FIG. 4 is a configuration diagram of a conventional machine learning device.

FIG. 5A and FIG. 5B are diagrams explaining a problem of a conventional machine learning device.

FIG. 6 is a configuration diagram of a machine learning device according to the first embodiment of the present disclosure.

FIG. 7 is a diagram explaining a method of meta learning performed by a conventional machine learning device.

FIG. 8 is a diagram explaining a method of meta learning performed by a machine learning device according to the first embodiment.

FIG. 9A and FIG. 9B are diagrams explaining effects of the machine learning device according to the first embodiment.

FIG. 10 is a configuration diagram of a machine learning device according to the second embodiment of the present disclosure.

FIG. 11 is a diagram explaining a method of meta learning performed by a machine learning device according to the second embodiment.

### DETAILED DESCRIPTION

The invention will now be described by reference to the preferred embodiments. This does not intend to limit the scope of the present invention, but to exemplify the invention.

First, an explanation will be given regarding an overview of incremental few-shot learning with XtarNet. In XtarNet, extraction of task-adaptive representations (TAR) is leaned. First, a backbone network that has been pretrained on a base class dataset is used so as to obtain features of the base class. An additional module that has been meta-trained across the episodes of a novel class is then used so as to obtain the features of the novel class. The merged product of the features of the base class and the features of the novel class is called a task-adaptive representation (TAR). Classifiers for the base and novel classes use this TAR to quickly adapt to a given task and perform a classification task.

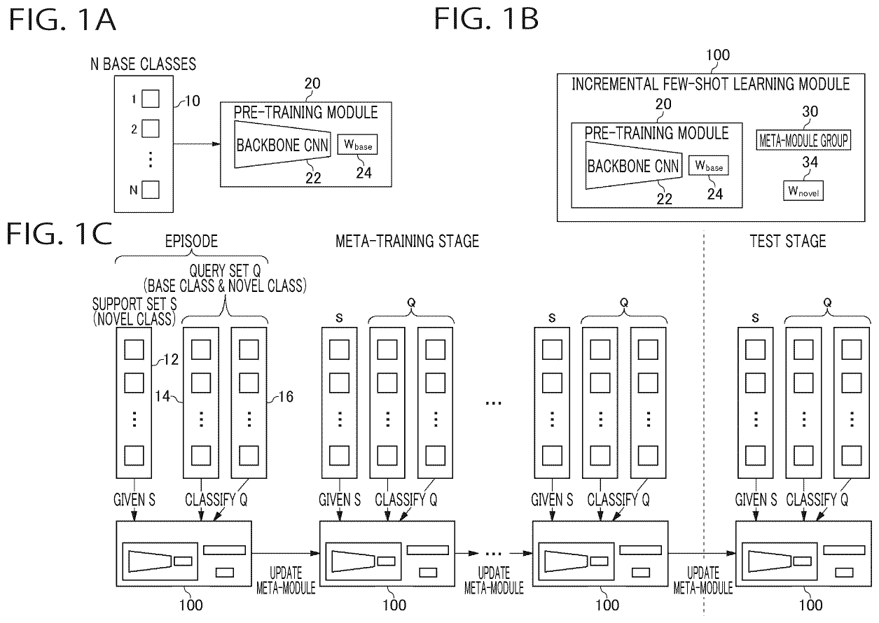

The outline of an XtarNet learning procedure will be explained with reference to FIGS. 1A to 1C.

FIG. 1A is a diagram explaining the configuration of a pre-training module 20. The pre-training module 20 includes a backbone CNN 22 and a base class classification weight 24.

A dataset 10 of a base class includes N samples. An example of the samples is an image but is not limited thereto. A backbone CNN 22 is a convolutional neural network that pre-learns the dataset 10 of the base class. The base class classification weight 24 represents a weight vector W_{base} of the base class classifier and indicates the average feature amount of the samples of the dataset 10 of the base class.

In a learning stage 1, the backbone CNN 22 is pretrained on the dataset 10 of the base class.

FIG. 1B is a diagram explaining the configuration of an incremental few-shot learning module 100. The incremental few-shot learning module 100 is a meta-module group 30 and a novel class classification weight 34 added to the pre-training module 20 shown in FIG. 1A. The meta-module group 30 includes three multilayer neural networks described later and performs post-learning on the dataset of a novel class. The number of samples included in the dataset of the novel class is smaller compared to the number of samples included in the dataset of the base class. The novel class classification weight 34 represents a weight vector Wₙₒᵥₑₗ of the novel class classifier and indicates the average feature amount of the samples of the dataset of the novel class.

In a learning stage 2, the meta-module group 30 is episodically trained based on the pre-training module 20.

FIG. 1C is a diagram explaining episodic training. The episodic training includes a meta-training stage and a test stage. The meta-training stage is executed for each episode, and the meta-module group 30 and the novel class classification weight 34 are updated. The test stage performs a classification test using the meta-module group 30 and novel class classification weight 34 updated in the meta-training stage.

Each episode consists of a support set S and a query set Q. The support set S consists of a dataset 12 of the novel class, and the query set Q consists of a dataset 14 of the base class and a dataset 16 of the novel class. In the learning stage 2, in each episode, query samples of both the base class and the novel class included in the query set Q are classified into classes based on a support sample of the given support set S, and the parameters of the meta-module group 30 and the novel class classification weight 34 are updated to minimize class classification loss.

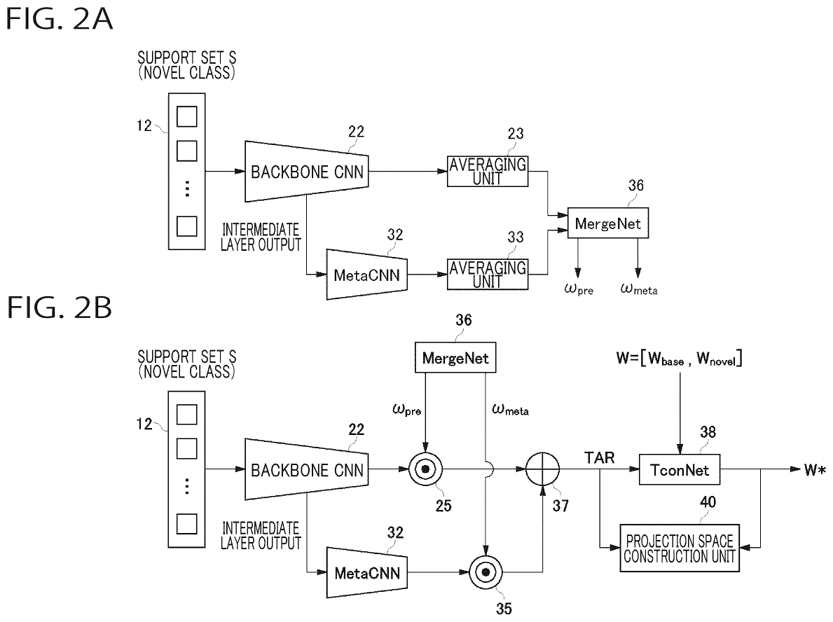

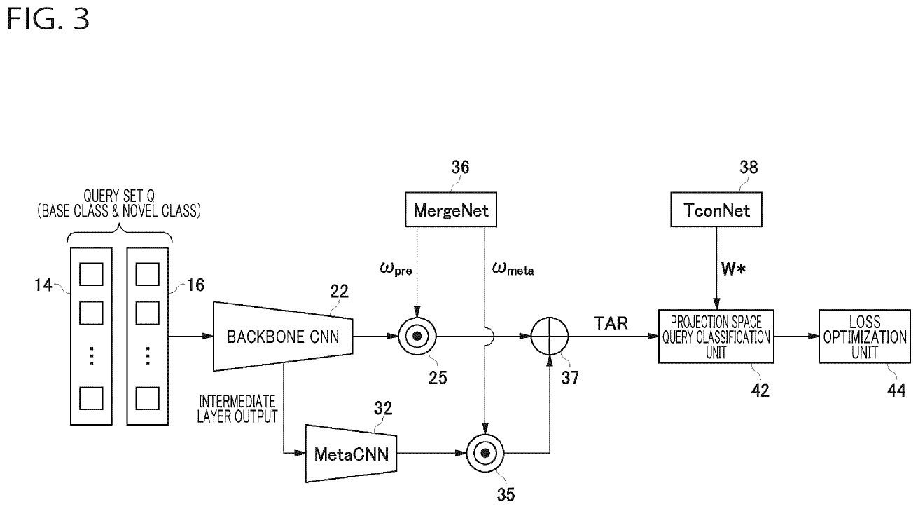

With reference to FIGS. 2A and 2B, the configuration related to the processing of the support set S in XtarNet will be explained, and with reference to FIG. 3, the configuration and learning process related to the processing of query set Q in XtarNet will be explained.

In addition to the backbone CNN 22, XtarNet utilizes the following three different meta-learnable modules as the meta-module group 30.
(1) MetaCNN: a neural network for extracting the features of a novel class
(2) MergeNet: a neural network for merging the features of the base class with the features of the novel class
(3) TconNet: a neural network for adjusting the weight of a classifier

FIG. 2A is a diagram explaining a configuration for generating task-specific merged weight vectors ωₚᵣₑ and ωₘₑₜₐ for calculating a task-adaptive representation from the support set S.

The support set S includes the dataset 12 of the novel class. Each support sample of the support set S is input into the backbone CNN22. The backbone CNN 22 processes the support sample, outputs a feature vector of the base class, which is referred to as “base feature vector,” and supplies the feature vector to an averaging unit 23. The averaging unit 23 calculates the average base feature vector by averaging the base feature vector output by the backbone CNN 22 for all support samples, and inputs the average base feature vector to MergeNet 36.

Output of an intermediate layer of the backbone CNN 22 is input to a MetaCNN 32. The MetaCNN 32 processes the output of the intermediate layer of the backbone CNN 22, outputs a feature vector of the novel class, which is referred to as “novel feature vector,” and supplies the feature vector to the averaging unit 33. The averaging unit 33 calculates the average novel feature vector by averaging the novel feature vector output by the MetaCNN 32 for all the support samples, and inputs the average novel feature vector to the MergeNet 36.

The MergeNet 36 processes the average base feature vector and the average novel feature vector with a neural network and outputs the task-specific merged weight vectors ωₚᵣₑ and ωₘₑₜₐ for calculating a task-adaptive representation TAR.

The backbone CNN 22 operates as a base feature vector extractor f_{θ} for extracting a base feature vector for input x, and outputs a base feature vector f_{θ}(x) for the input x. The intermediate layer output of the backbone CNN 22 for the input x is denoted as aₑ (x). The MetaCNN 32 operates as a novel feature vector extractor g for extracting a novel feature vector for the intermediate layer output aₑ (x) and outputs a novel feature vector g(a_{θ}(x)) for the intermediate layer output a_{θ}(x).

FIG. 2B is a diagram explaining a configuration for calculating a task-adaptive representation TAR from the support set S so as to generate a classification weight vector set W based on the task-adaptive representation TAR.

A vector product arithmetic unit 25 calculates the product for each element between the base feature vector f_{θ}(x) output from the backbone CNN 22 and the merged weight vector ωₚᵣₑ output from MergeNet 36 for each support sample x of the support set S, and outputs the product to a vector sum arithmetic unit 37.

A vector product arithmetic unit 35 calculates the product for each element between the novel feature vector g(a_{θ}(x)) output from the MetaCNN 32 and the merged weight vector ωₘₑₜₐ output from a MergeNet 36 for the intermediate layer output aₑ (x) of the backbone CNN 22 for each support sample x of the support set S, and outputs the product to the vector sum arithmetic unit 37.

The vector sum arithmetic unit 37 calculates the vector sum of the product of the base feature vector f_{θ}(x) and the merged weight vector ωₚᵣₑ and the product of the novel feature vector g(a_{θ}(x)) and the merged weight vector ωₘₑₜₐ, outputs the vector sum as a task-adaptive representation TAR of each support sample x of the support set S, and provides the task-adaptive representation TAR to a TconNet 38 and a projection space construction unit 40. The task-adaptive representation TAR is a merged feature vector consisting of a merged product of the base feature vector and the novel feature vector.

The calculation formula for the task-adaptive representation TAR is as follows, where the product of each component of a vector is expressed as x.

$$TAR = {ω}_{p r e} \times {f}_{θ} ( x ) + {ω}_{m e t a} \times g ( {a}_{θ} ( x ) )$$

The calculation formula for the task adaptive representation TAR is to find the sum of element-by-element products between the merged weight vector and the feature vector. The task adaptive representation TAR is calculated for each support sample in the support set S.

The TconNet 38 receives the input of a classification weight vector set W=[W_{base}, Wₙₒᵥₑₗ], and outputs a task-adjusted classification weight vector set W* using the task adaptive representation TAR of each support sample.

The projection space construction unit 40 constructs a task-adaptive projection space M such that the average {Cₖ} for each class k of the task-adaptive representation TAR of each support sample and W* obtained after task adjustment align in the projection space M.

FIG. 3 is a diagram explaining a configuration for calculating a task-adaptive representation TAR from a query set Q and classifying a query sample into a class based on the task-adaptive representation TAR and a task-adjusted classification weight vector set W* so as to minimize class classification loss.

The vector product arithmetic unit 25 calculates the product for each element between the base feature vector f_{θ}(x) output from the backbone CNN 22 and the merged weight vector ωₚᵣₑ output from the MergeNet 36 for each query sample x of the query set Q, and outputs the product to the vector sum arithmetic unit 37.

The vector product arithmetic unit 35 calculates the product for each element between the novel feature vector g(a_{θ}(x)) output from the MetaCNN 32 and the merged weight vector ωₘₑₜₐ output from the MergeNet 36 for the intermediate layer output aₑ (x) of the backbone CNN 22 for each query sample x of the query set Q, and outputs the product to the vector sum arithmetic unit 37.

The vector sum arithmetic unit 37 calculates the vector sum of the product of the base feature vector f_{θ}(x) and the merged weight vector ωₚᵣₑ and the product of the novel feature vector g(a_{θ}(x)) and the merged weight vector ωₘₑₜₐ, outputs the vector sum as a task-adaptive representation TAR of each query sample x of the query set Q, and provides the task-adaptive representation TAR to a projection space query classification unit 42.

The task-adjusted classification weight vector set W* output by the TconNet 38 is input to the projection space query classification unit 42.

The projection space query classification unit 42 calculates the Euclidean distance between the position of the task-adaptive representation TAR calculated for each query sample of the query set Q and the position of the average feature vector of a classification target class in the projection space M, and classifies the query sample into the closest class. It should be noted here that by the operation of the projection space construction unit 40, the average position of the classification target class in the projection space M aligns with the task-adjusted classification weight vector set W*.

A loss optimization unit 44 evaluates the class classification loss in the query sample by a cross-entropy function, and proceeds with learning such that the classification result of the query set Q approaches the correct answer so as to minimize the class classification loss. This allows learnable parameters of the MetaCNN 32, the MergeNet 36, and the TconNet 38 and a novel class classification weight Wₙₒᵥₑₗ to be updated such that the distance between the position of the task-adaptive representation TAR calculated for the query sample and the position of the average feature vector of the classification target class, i.e., the position of the task-adjusted classification weight vector set W*, becomes small.

### First Embodiment

In explaining a machine learning device 210 according to the first embodiment of the present disclosure, a conventional machine learning device 200 will be explained as a premise.

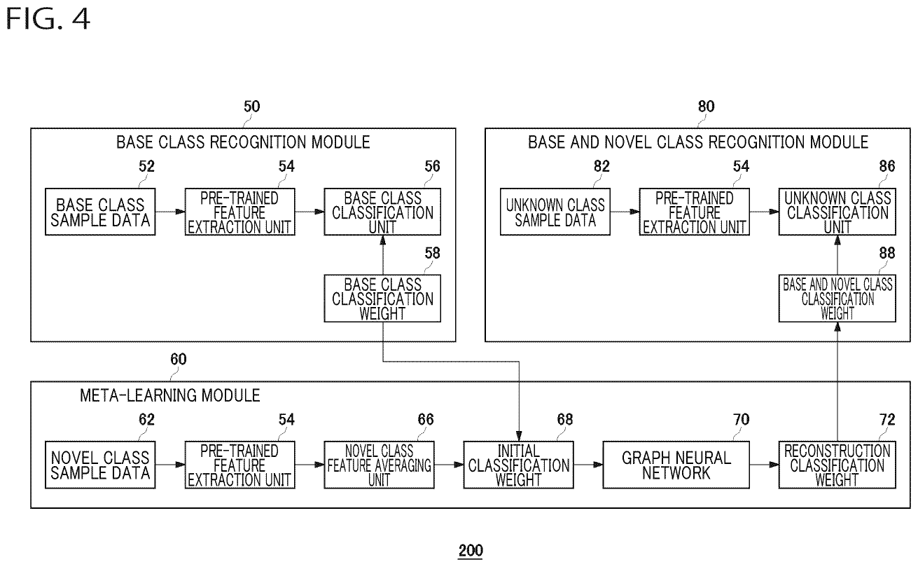

FIG. 4 is a configuration diagram of the conventional machine learning device 200. An explanation will be given regarding the configuration of the reconstruction of a class classification weight (prototype) using the graph neural network 70 described in Non-Patent Literature 2.

The machine learning device 200 learns to reconstruct the class classification weight in incremental few-shot learning. Pretraining is performed on a base class dataset so as to obtain a trained feature extractor for the base class and the class classification weight of the base class. The classification weights of novel classes with a small number of samples are calculated using the trained feature extractor. In the task of incremental few-shot learning, the base class and the novel classes need to be classified jointly. The classification weight of the base class and the classification weights of the novel classes are simultaneously input to the graph neural network 70, and classification weights after the reconstruction are output. Meta-learning of the graph neural network 70, which allows for the learning of the interdependent relationship between the base class and the novel classes, is performed so as to obtain the optimal class classification weights for joint classification.

The machine learning device 200 includes a base class recognition module 50, a meta-learning module 60, and a base and novel class recognition module 80.

The base class recognition module 50 pre-trains the base class feature extractor and the classification weight of the base class using the training data of the base class, and generates a pre-trained model. The figure illustrates a pre-trained base class feature extraction unit as a pre-trained feature extraction unit 54 and illustrates the pre-trained base class classification weight as a base class classification weight 58.

The meta-learning module 60 performs meta-learning of a meta-module that is based on the pre-trained model of the base class recognition module 50 using training data for the novel classes. Meta-learning of the meta-module is performed in an episodic learning form. A support set consists of samples in the novel classes, and a query set consists of samples in the base class and samples in the novel classes. This learning is intended to classify query samples from both the base class and the novel classes based on the support set.

The base and novel class recognition module 80 classifies unknown classes using the meta-module meta-learned in the meta-learning module 60.

In the base class recognition module 50, the pre-trained feature extraction unit 54 uses base class sample data 52 as input and extracts the feature vector of a sample of the base class using the pre-trained model. A base class classification unit 56 uses the feature vectors of the samples in the base class as input and classifies the samples in the base class using the base class classification weight 58.

In the conventional machine learning device 200, since the pre-trained model generated in the base class recognition module 50 is directly used for feature extraction of samples in a novel class in the meta-learning module 60, the pre-trained feature extraction unit 54 of the meta-learning module 60 is the same as the pre-trained feature extraction unit 54 of the base class recognition module 50.

In the meta-learning module 60 of the conventional machine learning device 200, only the graph neural network 70 is subject to meta-learning. Based on the pre-trained model, the graph neural network 70, which is a meta-module, is trained in an episodic manner. For a support set consisting of novel classes, feature vectors output from the pre-trained feature extraction unit 54 are averaged for each class, and the classification weights of the novel classes are calculated. The classification weight of the basic class and the classification weights of the novel classes are both input to the graph neural network 70, and classification weights after the reconstruction are output. The parameters of the graph neural network 70 are optimized with a query set consisting of the base class and the novel classes. For the optimization method for the graph neural network 70, the method described in Non-Patent Literature 2 is used.

In the meta-learning module 60, the pre-trained feature extraction unit 54 uses novel class sample data 62 as input and extracts the feature vectors of samples in the novel classes using the pre-trained model. A novel class feature averaging unit 66 averages the feature vectors of the samples in the novel classes for each class and calculates the classification weights of the novel classes.

The base class classification weight 58 used by the base class classification unit 56 of the base class recognition module 50 and the classification weights of the novel classes output by the novel class feature averaging unit 66 are combined and input to the graph neural network 70 as an initial classification weight 68.

The graph neural network 70 uses the initial classification weight 68, which is a combination of the classification weight of the base class and the classification weights of the novel classes, as input, performs meta-learning of the dependence relationship between the base class and the novel classes, and outputs a reconstruction classification weight 72.

The base and novel class recognition module 80 uses the reconstruction classification weight 72 meta-learned by the graph neural network 70 as a base and novel class classification weight 88.

In the conventional machine learning device 200, since the pre-trained model generated in the base class recognition module 50 is directly used for feature extraction of samples in an unknown class in the base and novel class recognition module 80, the pre-trained feature extraction unit 54 of the base and novel class recognition module 80 is the same as the pre-trained feature extraction unit 54 of the base class recognition module 50.

Using the classification weight obtained after the reconstruction, the base and novel class recognition module 80 of the conventional machine learning device 200 performs a distance calculation on test samples consisting of the base class and the novel classes with respect to the classification weight obtained after the reconstruction and classifies the test samples into a class with the closest distance.

In the base and novel class recognition module 80, the pre-trained feature extraction unit 54 uses unknown class sample data 82 as input and extracts the feature vector of a sample of the unknown class using the pre-trained model. An unknown class classification unit 86 uses the feature vector of the sample of the unknown class as input and classifies the sample of the unknown class using the reconstructed base and novel class classification weight 88. More specifically, the unknown class classification unit 86 classifies the sample of the unknown class into a class with the closest distance between the feature vector of the sample of the unknown class and the reconstructed base and novel class classification weight 88.

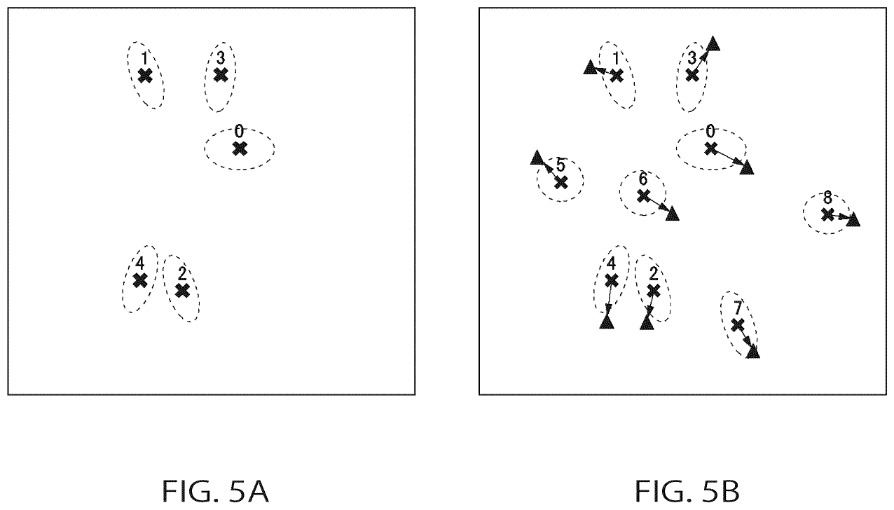

FIG. 5A and FIG. 5B are diagrams explaining a problem of a conventional machine learning device 200. The figures illustrate the feature vector of each image sample and the classification weight of each class that are visualized in a two-dimensional space.

FIG. 5A shows the feature vectors and classification weights of image samples in five base classes (numbered 0 to 4) after pre-training. For each base class, the classification weight is denoted by x, and the set of feature vectors of the image samples is indicated by a dotted enclosure.

FIG. 5B shows the feature vectors and classification weights of image samples in five base classes (numbered 0 to 4) and four novel classes (numbered 5 to 8). For each class, the classification weight before reconstruction is denoted by x, the classification weight after reconstruction is indicated by a triangle, and the set of feature vectors of the image samples is indicated by a dotted enclosure. The change in classification weights before and after reconstruction is indicated by arrows.

The classification weights after the reconstruction move in the direction of achieving good class classification boundaries; however, since the feature vector of each image sample itself does not change, the set of the feature vectors of the image samples (illustrated by dotted enclosures) and the classification weights after the reconstruction (illustrated by triangles) of corresponding classes are separated, and there is a risk that the class classification accuracy may be lowered.

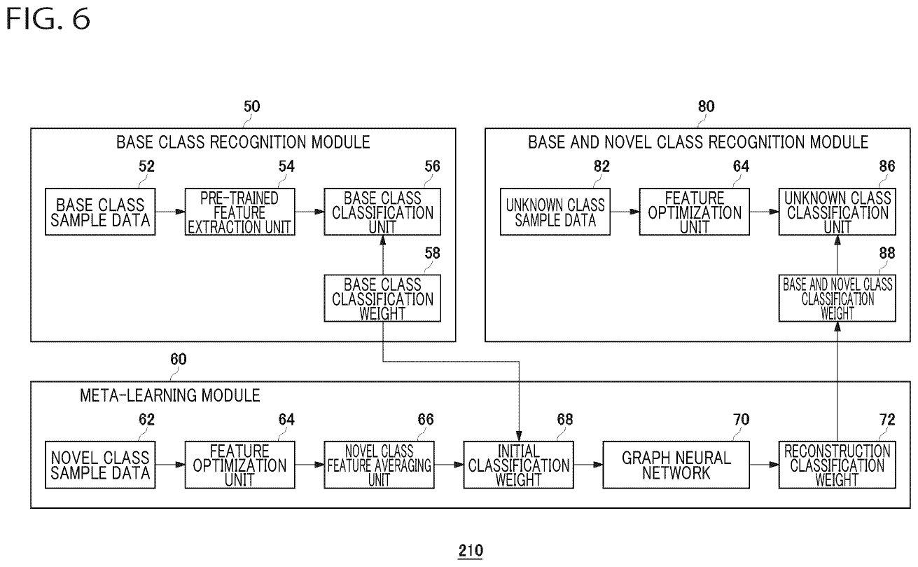

FIG. 6 is a configuration diagram of a machine learning device 210 according to the first embodiment of the present disclosure. In the conventional machine learning device 200, the pre-trained feature extraction unit 54 of the base class recognition module 50 is directly used in the meta-learning module 60 and the base and novel class recognition module 80. Meanwhile, in the machine learning device 210 according to the first embodiment, a feature optimization unit 64 is used instead of the pre-trained feature extraction unit 54 of the base class recognition module 50 in the base class recognition module 50 in the meta-learning module 60 and the base and novel class recognition module 80. The conventional machine learning device 200 and the machine learning device 210 are different in this regard and are the same regarding the rest of the structures. Thus, an explanation will be given mainly regarding the differences, and the explanation of common features is omitted as appropriate.

In the conventional machine learning device 200, only the graph neural network 70 is subject to meta-learning in the meta-learning module 60. However, in the machine learning device 210 according to the first embodiment, the feature optimization unit 64 and the graph neural network 70 are subject to meta-learning in the meta-learning module 60.

The feature optimization unit 64 includes an optimization module that is based on the pre-trained model of the pre-trained feature extraction unit 54 of the meta-learning module 60. An example of the feature optimization unit 64 is XtarNet described above. In XtarNet, a meta-module group 30 is episodically trained based on the pre-training module 20 that has pre-trained the base class. The feature optimization unit 64 can be realized using any meta-module, not limited to XtarNet, as long as the meta-modules can be updated by training data of novel classes based on a pre-trained model of the base class in the same way as in XtarNet.

In the meta-learning module 60 of the machine learning device 210 according to the first embodiment, the graph neural network 70 and the feature optimization unit 64 are subject to meta-learning. Based on the pre-trained model, the graph neural network 70 and the feature optimization unit 64, which are meta-modules, are trained in an episodic manner. For a support set consisting of novel classes, feature vectors output from the feature optimization unit 64 are averaged for each class, and the classification weights of the novel classes are calculated. The classification weight of the basic class and the classification weights of the novel classes are both input to the graph neural network 70, and classification weights after the reconstruction are output. The parameters of the graph neural network 70 and the parameters of the feature optimization unit 64 are optimized with a query set consisting of the base class and the novel classes. For the optimization method for the graph neural network 70, the method described in Non-Patent Literature 2 is used. An example of the optimization method of the feature optimization unit 64 is a method of learning to minimize the cross-entropy loss of the query set. The optimization by the feature optimization unit 64 allows for adjustment of the feature vectors of the samples in a direction that brings the feature vectors of the samples closer to the classification weights after the reconstruction.

The feature optimization unit 64 updates the parameters of the meta-module by meta-learning the novel classes and optimizing the feature vectors of the samples in the novel classes, while keeping the pre-trained model in which the basic class has been learned fixed.

The initial classification weight 68 averages the optimized feature vectors of the samples in the novel classes for each class and calculates the classification weights of the novel classes.

The base class classification weight 58 used by the base class classification unit 56 of the base class recognition module 50 and the optimized classification weights of the novel classes output by the novel class feature averaging unit 66 are combined and input to the graph neural network 70 as an initial classification weight 68.

The graph neural network 70 uses the initial classification weight 68, which is a combination of the classification weight of the base class and the optimized classification weights of the novel classes, as input, performs meta-learning of the dependence relationship between the base class and the novel classes, and outputs a reconstruction classification weight 72.

The base and novel class recognition module 80 uses the reconstruction classification weight 72 meta-learned by the graph neural network 70 as a base and novel class classification weight 88.

In machine learning device 210 according to the first embodiment, since an optimization module generated in the meta-learning module 60 is used for feature extraction of samples in an unknown class in the meta-learning module 60, the feature optimization unit 64 of the base and novel class recognition module 80 is the same as the feature optimization unit 64 of the meta-learning module 60.

In the base and novel class recognition module 80, the feature optimization unit 64 uses unknown class sample data 82 as input and extracts the feature vector of a sample of the unknown class using the optimization module. An unknown class classification unit 86 uses the feature vector of the sample of the unknown class as input and classifies the sample of the unknown class using the reconstructed base and novel class classification weight 88. More specifically, the unknown class classification unit 86 classifies the sample of the unknown class into a class with the closest distance between the feature vector of the sample of the unknown class and the reconstructed base and novel class classification weight 88.

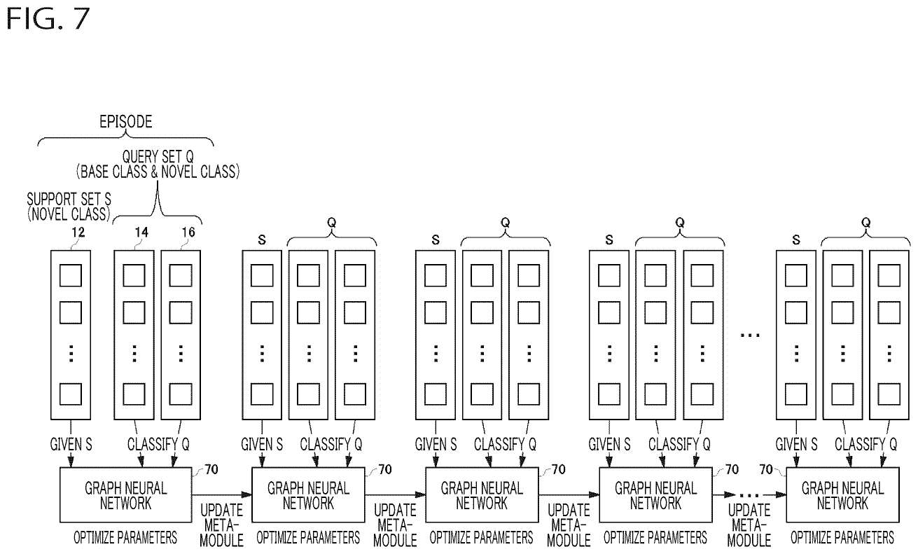

FIG. 7 is a diagram explaining a method of meta learning performed by a conventional machine learning device 200. The meta-learning module 60 of the conventional machine learning device 200 optimizes the parameters of the graph neural network 70, which is a meta-module, for each episode and updates the graph neural network 70.

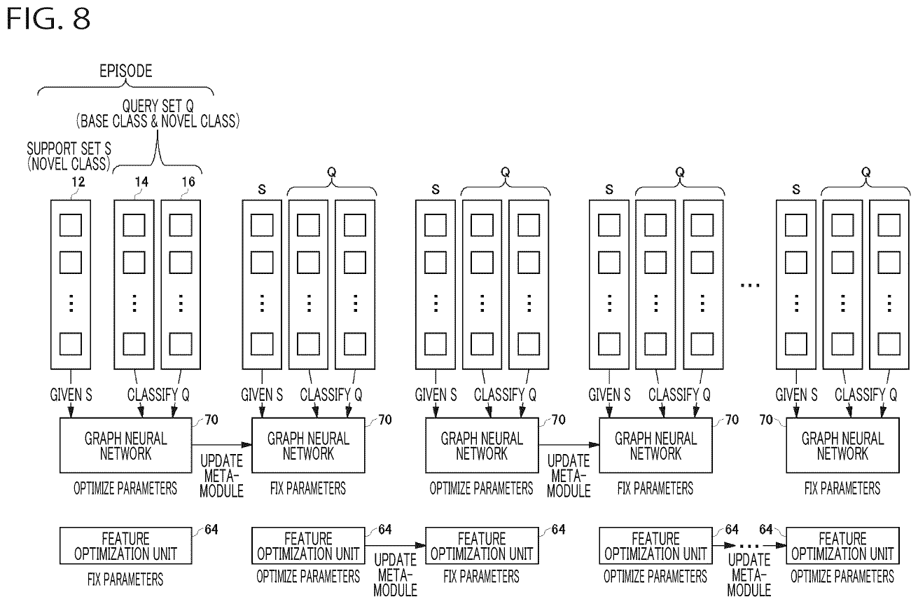

FIG. 8 is a diagram explaining a method of meta learning performed by the machine learning device 210 according to the first embodiment. In the meta-learning module 60 of the machine learning device 210 according to the first embodiment, the graph neural network 70, which is a meta-module, and the feature optimization unit 64 are alternately optimized and updated for each episode.

Each episode consists of a support set S and a query set Q. The support set S consists of a dataset 12 of the novel class, and the query set Q consists of a dataset 14 of the base class and a dataset 16 of the novel class. In a meta-learning stage, in each episode, query samples in both the base class and the novel class included in the query set Q are classified into classes based on a support sample of the given support set S, and the graph neural network 70 or the feature optimization unit 64 is updated so as to minimize the loss of the classification into classes.

In odd-numbered episodes, the parameters of the feature optimization unit 64 are fixed, the parameters of the graph neural network 70 are optimized, and only the graph neural network 70 is updated.

In even-numbered episodes, the parameters of the graph neural network 70 are fixed, the parameters of the feature optimization unit 64 are optimized, and only the feature optimization unit 64 is updated.

In this way, mutual learning of the graph neural network 70 and the feature optimization unit 64 is repeated. The mutual learning is not limited to one unit of episode and may be performed for several units of episodes.

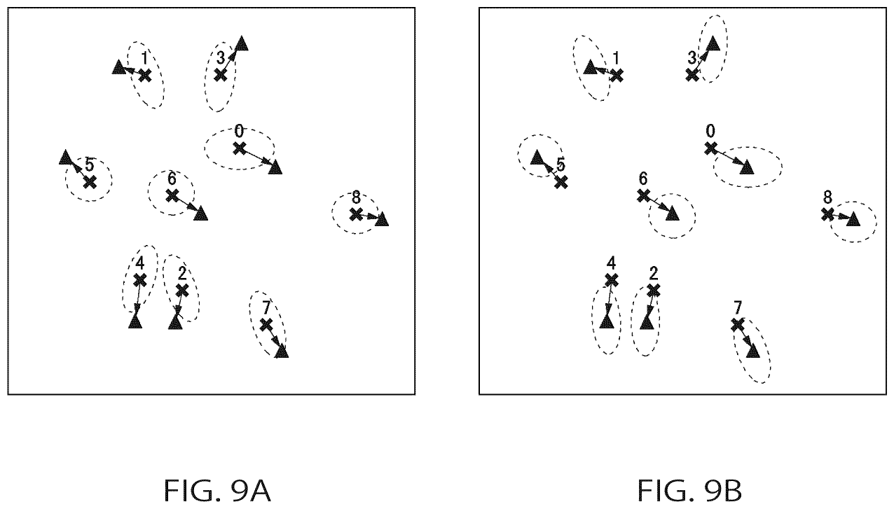

FIGS. 9A and 9B are diagrams explaining effects of the machine learning device 210 according to the first embodiment. The figures illustrate the feature vector of each image sample and the classification weight of each class that are visualized in a two-dimensional space.

FIG. 9A shows the results of the reconstruction of classification weights performed by the conventional machine learning device 200 for comparison, and shows the feature vectors and classification weights of image samples in five base classes (numbered 0 to 4) and four novel classes (numbered 5 to 8) in the same way as in FIG. 5B. For each class, the classification weight before reconstruction is denoted by x, the classification weight after reconstruction is indicated by a triangle, and the set of feature vectors of the image samples is indicated by a dotted enclosure. The change in classification weights before and after reconstruction is indicated by arrows.

In the reconstruction of the classification weights by the conventional machine learning device 200, the classification weights move in the direction of achieving good class classification boundaries; however, since the feature vector of each image sample itself does not change, there is a risk that test samples are classified into wrong classes.

FIG. 9B shows the results of the reconstruction of classification weights performed by the machine learning device 210 according to the first embodiment. The classification weights after the reconstruction move in the direction of achieving good class classification boundaries, and the feature vectors of the respective image samples are also adjusted so as to approach the classification weights. Therefore, the set of feature vectors of the image samples (illustrated by dotted enclosures) and the classification weights after the reconstruction of the corresponding classes (illustrated by triangles) are not separated, avoiding a decrease in the class classification.

As described, according to the machine learning device 210 according to the first embodiment, by mutually learning the optimization of feature vectors and the reconstruction of classification weights, the feature vectors of the corresponding samples can be gathered near the classification weights after the reconstruction, and the class classification accuracy can be improved.

### Second Embodiment

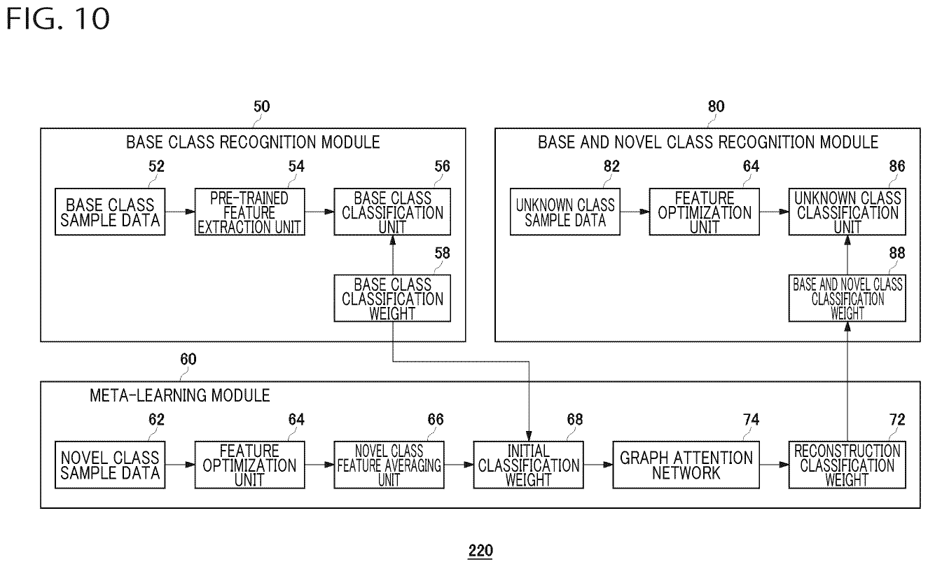

FIG. 10 is a configuration diagram of a machine learning device 220 according to the second embodiment of the present disclosure.

In the meta-learning module 60 of the machine learning device 210 according to the first embodiment, a graph neural network 70 is used as a meta-module. However, in the meta-learning module 60 of the machine learning device 220 according to the second embodiment, a Graph Attention Network 74 according to Non-Patent Literature 3 is used instead of the graph neural network 70. The rest of the structures of the machine learning device 200 according to the second embodiment are the same as those of the machine learning device 210 according to the first embodiment. Thus, an explanation will be given mainly regarding the differences, and the explanation of common features is omitted as appropriate.

Continuously evolved classifiers (CEC) described in Non-Patent Literature 3 meta-learn the graph attention network 74 in an episodic manner by sampling novel classes with a small number of samples pseudo-created from the basic class as pseudo-incremental tasks based on a backbone model R in which the basic class has been learned.

In the graph neural network 70, a support set of an episode consists only of samples in the novel classes, and a query set consists of samples in the base class and the novel classes. The graph attention network 74 is different in that both the support set and the query set consist of the samples in the base class and the novel classes.

Just like the feature optimization unit 64 of the machine learning device 210 according to the first embodiment, an example of the feature optimization unit 64 of the machine learning device 220 according to the second embodiment is XtarNet.

In the meta-learning module 60 of the machine learning device 220 according to the second embodiment, the graph attention network 74 and the feature optimization unit 64 are subject to meta-learning. By sampling the pseudo-incremental tasks from the basic class, meta-learning is performed on the graph attention network 74, which is a meta-module, and the feature optimization unit 64. For a support set consisting of the base class and the novel classes, feature vectors output from the feature optimization unit 64 are averaged for each class, and the classification weight of the base class and the classification weights of the novel classes are calculated. The classification weight of the basic class and the classification weights of the novel classes are both input to the graph attention network 74, and classification weights after the reconstruction are output. The parameters of the graph attention network 74 and the parameters of the feature optimization unit 64 are optimized with a query set consisting of the base class and the novel classes. For the optimization method for the graph attention network 74, the method described in Non-Patent Literature 3 is used. An example of the optimization method of the feature optimization unit 64 is a method of learning to minimize the cross-entropy loss of the query set. The optimization by the feature optimization unit 64 allows for adjustment of the feature vectors of the samples in a direction that brings the feature vectors of the samples closer to the classification weights after the reconstruction.

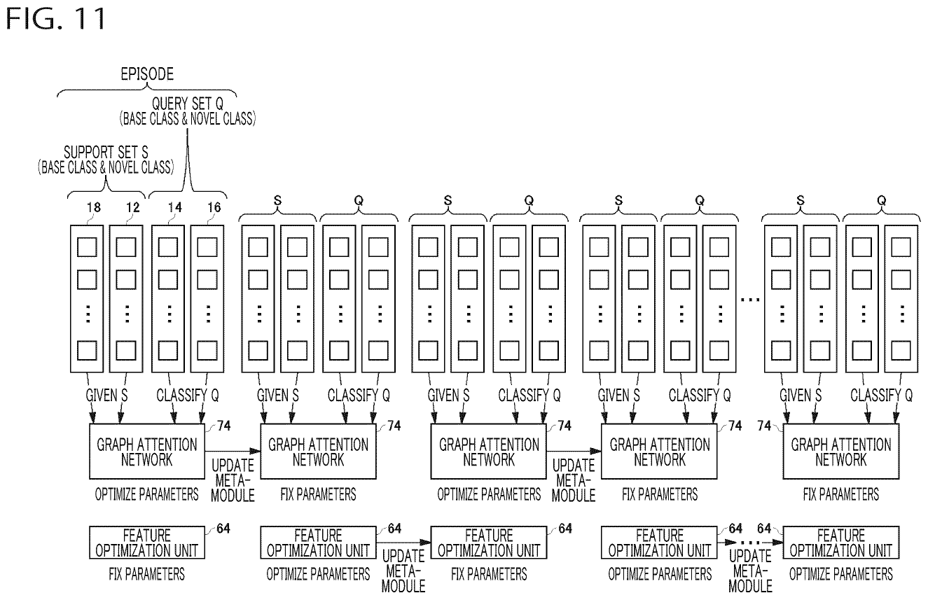

FIG. 11 is a diagram explaining a method of meta learning performed by the machine learning device 220 according to the second embodiment. In the meta-learning module 60 of the machine learning device 220 according to the second embodiment, the graph attention network 74, which is a meta-module, and the feature optimization unit 64 are alternately optimized and updated for each episode.

Each episode consists of a support set S and a query set Q. The support set S consists of a dataset 18 of a base class and a dataset 12 of a novel class, and the query set Q consists of a dataset 14 of a base class and a dataset 16 of a novel class. In a meta-learning stage, in each episode, query samples of both the base class and the novel class included in the query set Q are classified into classes based on a support sample of the given support set S, and the graph attention network 74 or the feature optimization unit 64 is updated so as to minimize the loss of the classification into classes.

In odd-numbered episodes, the parameters of the feature optimization unit 64 are fixed, the parameters of the graph attention network 74 are optimized, and only the graph attention network 74 is updated.

In even-numbered episodes, the parameters of the graph attention network 74 are fixed, the parameters of the feature optimization unit 64 are optimized, and only the feature optimization unit 64 is updated.

In this way, mutual learning of the graph attention network 74 and the feature optimization unit 64 is repeated. The mutual learning is not limited to one unit of episode and may be performed for several units of episodes.

The above-described various processes in the machine learning devices 210 and 220 can of course be implemented by hardware-based devices such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the programs may be transmitted to and/or received from a server via a wired or wireless network. Still alternatively, the programs may be transmitted and/or received in the form of data transmission over terrestrial or satellite digital broadcast systems.

As described above, according to the machine learning devices 210 and 220 according to the first and second embodiments, a structure for optimizing the features of each class is added, and the optimization of the features of each class and the reconstruction of the classification weight of each class are mutually learned. Since not only the classification weight of each class is reconstructed but also the feature space of the samples in each class itself is reconstructed, it is possible to improve the accuracy of class classification.

Described above is an explanation of the present disclosure based on the embodiments. The embodiments are intended to be illustrative only, and it will be obvious to those skilled in the art that various modifications to constituting elements and processes could be developed and that such modifications are also within the scope of the present disclosure.

What is claimed is:

1. A machine learning device that performs continual learning of a novel class with fewer samples than a base class, comprising:
a base class feature extraction unit that extracts feature vectors of samples in the base class using a pre-trained model;
a base class classification unit that uses feature vectors of the samples in the base class as input and classifies the samples in the base class using the classification weight of the base class;
a feature optimization unit that performs meta-learning of an optimization module that is based on the pre-trained model and optimizes feature vectors of samples in the novel class;
a novel class feature averaging unit that averages the feature vectors of the samples in the novel class for each class and calculates the classification weight of the novel class;
a graph neural network or a graph attention network that uses the classification weight of the base class and the classification weight of the novel class as input, performs meta-learning of the dependence relationship between the base class and the novel class, and outputs a reconstruction classification weight; and
an unknown class classification unit that uses, as input, feature vectors of samples in an unknown class extracted using the optimization module and classifies the samples in the unknown class using the reconstruction classification weight.

2. The machine learning device according to claim 1,
wherein parameters of the feature optimization unit are fixed at the time of learning of parameters of the graph neural network while the parameters of the graph neural network are fixed at the time of learning of the parameters of the feature optimization unit when the meta-learning is performed in units of episodes.

3. A machine learning method that performs continual learning of a novel class with fewer samples than a base class, comprising:
extracting feature vectors of samples in the base class using a pre-trained model;
using feature vectors of the samples in the base class as input and classifying the samples in the base class using the classification weight of the base class;
performing meta-learning of an optimization module that is based on the pre-trained model and optimizing feature vectors of samples in the novel class;
averaging the feature vectors of the samples in the novel class for each class and calculating the classification weights of the novel classes;
using the classification weight of the base class and the classification weight of the novel class as input, performing meta-learning of the dependence relationship between the base class and the novel class, and outputting a reconstruction classification weight, while using a graph neural network or a graph attention network; and
using, as input, feature vectors of samples in an unknown class extracted using the optimization module and classifying the samples in the unknown class using the reconstruction classification weight.

4. A non-transitory computer-readable medium having a machine learning program that performs continual learning of a novel class with fewer samples than a base class, the program comprising computer-implemented modules including:
a base class feature extraction module that extracts feature vectors of samples in the base class using a pre-trained model;
a base class classification module that uses feature vectors of the samples in the base class as input and classifies the samples in the base class using the classification weight of the base class;
a feature optimization module that performs meta-learning of an optimization module that is based on the pre-trained model and optimizes feature vectors of samples in the novel class;
a novel class feature averaging module that averages the feature vectors of the samples in the novel class for each class and calculates the classification weight of the novel class;
a module that uses the classification weight of the base class and the classification weight of the novel class as input, performs meta-learning of the dependence relationship between the base class and the novel class, and outputs a reconstruction classification weight, while using a graph neural network or a graph attention network; and
an unknown class classification module that uses, as input, feature vectors of samples in an unknown class extracted using the optimization module and classifies the samples in the unknown class using the reconstruction classification weight.
